(19) United States
(12) Patent Application Publication
(10) Pub. No.: US 2010/0321029 A1
(43) Pub. Date: Dec. 23, 2010

(54) PLASMA MEASURING METHOD, PLASMA MEASURING DEVICE AND STORAGE MEDIUM

(75) Inventors: Toru Ito, Yamanashi (JP); Masato Kawakami, Yamanashi (JP); Sumie Nagaseki, Yamanashi (JP); Kazuki Denpoh, Yamanashi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, TOKYO (JP)

(21) Appl. No.: 12/867,120

(22) PCT Filed: Jan. 30, 2009
(86) PCT No.: PCT/JP09/51610

§ 371 Date: Aug. 11, 2010

(30) Foreign Application Priority Data
Feb. 12, 2008 (JP) 2008-030833

(51) Int. Cl. G01N 27/62

(52) U.S. Cl. 324/464

(57) ABSTRACT

Provided is a technique capable of ascertaining the process condition of the boundary between electrically positive and negative plasma regions. In a vacuum chamber, one of the parameters of process conditions is stepwisely changed to generate a plasma under at least three process conditions. The parameters include a flow rate ratio between an electrically negative gas and an electrically positive gas, a pressure in the vacuum chamber and the magnitude of an energy supplied to the gases. Next, a voltage is applied to a Langmuir probe positioned in that plasma, and a current-voltage curve indicating the relationship between the applied voltage and the electric current to flow through the probe is acquired for each of the process conditions. On the basis of the current-voltage curve group acquired, the process conditions are determined for the boundary between the electrically positive and negative plasma regions.

### FIELD OF THE INVENTION

The present invention relates to a plasma measuring method for measuring electrical characteristics of a plasma generated in a vacuum chamber by supplying an energy to a plasma-generating gas containing an electrically negative gas and an electrically positive gas; and, more particularly, to a technique for ascertaining electrical characteristics of a plasma generated under predetermined process conditions based on a current-voltage curve of the plasma.

### BACKGROUND OF THE INVENTION

In a semiconductor device manufacturing process, a semiconductor device is manufactured by using a plasma technique for generating a plasma by applying an energy, e.g., a high frequency power, to a processing gas introduced into a processing chamber and performing an etching process or a film-forming process by using the plasma thus generated. In a plasma processing apparatus for performing such processes, it is required to improve in-plane uniformity of the processing. Meanwhile, a state of the plasma generated in the processing chamber is affected by process conditions such as a pressure in the processing chamber, a high frequency power, a composition of a processing gas and the like. Further, it is known that changes in parameters of the process conditions lead to changes in an electron density distribution of the generated plasma or an etching rate distribution in an etching process using the plasma.

Hence, an operator needs to create a plurality of processing recipes in which parameters of process conditions are changed in accordance with desired plasma processing, measure the electron density distribution of the plasma or the etching rate distribution for each of the processing recipes and select optimal ones from the parameters. However, the electron density distribution or the etching rate distribution varies by merely changing the flow rate ratio of the processing gas, so that the electron density distribution or the like needs to be measured whenever a single parameter is changed in order to obtain optimal parameters, which is a complicated operation.

Further, the electron density distribution is detected by positioning a plasma absorption probe (PAP) at a plurality of measurement locations of the same height in the processing chamber and measuring an electron density at each of the measurement locations. In this case, it is difficult to position the plasma absorption probe at the measurement locations of the same height while ensuring airtightness of the processing chamber. Moreover, it is complicated to perform this operation multiple times.

Meanwhile, in the processing using a plasma, an electrically negative gas such as CF₄ gas, SF₆ gas, Cl₂ gas, O₂ gas or the like is widely used. A plasma generated from such gas has negative ions and different properties from those of a plasma generated from an electrically positive gas such as Ar gas, N₂ gas or the like. In other words, the plasma generated from the electrically negative gas is an electrically negative plasma, and the plasma generated from the electrically positive gas is an electrically positive plasma. The electrically negative plasma and the electrically positive plasma have different electrical characteristics and properties from each other.

In, the electrically negative plasma, molecules of the electrically negative gas are bonded to the electrons in the plasma to generate negative ions so that the amount of the negative ions becomes greater than that of the electrons. It is believed that the plasma is neutral (quasi-neutral) and positive ions in the plasma are distributed in conformity with the distribution of the negative ions and the electrons. On the other hand, in the electrically positive plasma, the amount of negative ions is less than that of electrons.

However, as for the processing gas, a gaseous mixture of an electrically negative gas and an electrically positive gas is often used. By controlling a flow rate ratio of the gaseous mixture, the generated plasma may be changed into an electrically negative or positive plasma. Therefore, if it is possible to determine whether an electrically negative or positive plasma is generated under certain process conditions, it is easy to obtain a measure to increase in-plane uniformity of the etching rate distribution in the process conditions by, e.g., addition of the electrically negative gas, and to optimize the parameters to improve the in-plane uniformity of the etching rate distribution.

Further, even if the electrically negative gas and the electrically positive gas have the same flow rate ratio, the electrical characteristic of the plasma may be changed between an electrically negative state and an electrically positive state by merely controlling the process conditions such as a pressure in the processing chamber, a high frequency power for turning a processing gas into a plasma, and the like. Under the circumstance, it is difficult to determine whether an electrically negative or positive plasma is generated under certain process conditions and no determining method thereof is established.

Japanese Patent Application publication No. H11-031686 (JP H11-031686A) describes a method for increasing in-plane uniformity of an electron density distribution of a plasma, and Japanese Patent Application publication No. 2005-033062 (JP2005-033062A) describes a method for increasing in-plane uniformity of an etching rate distribution. However, JP H11-031686A and JP2005-033062A disclose neither a method for determining whether a generated plasma is an electrically positive plasma or an electrically negative plasma nor a method for easily setting process conditions capable of ensuring high in-plane uniformity of the electron density distribution or the etching rate distribution. Accordingly, it is difficult to solve the above-mentioned problem.

### SUMMARY OF THE INVENTION

In view of the above, the present invention provides a technique capable of ascertaining process conditions of a boundary between an electrically positive plasma region and an electrically negative plasma region, and a technique capable of determining whether a plasma generated under certain process conditions is an electrically negative plasma or an electrically positive plasma.

In accordance with an aspect of the present invention, there is provided a plasma measuring method for measuring electrical characteristics of a plasma in a vacuum chamber by using a Langmuir probe positioned in the plasma, the plasma being generated by supplying an energy to a plasma-generating gas containing an electrically negative gas and an electrically positive gas supplied into the vacuum chamber. The plasma measuring method includes: stepwisely changing one or more of parameters of process conditions to generate plasmas under at least three process conditions, the parameters including a flow rate ratio between the electrically negative gas and the electrically positive gas included in the plasma-generating gas supplied into the vacuum chamber, a pressure in the vacuum chamber and a magnitude of the energy; applying a voltage to the Langmuir probe positioned in the plasma and acquiring a current-voltage curve group by creating current-voltage curves indicating relationships between the applied voltage and a corresponding current to flow through the probe for each of the process conditions; and ascertaining process conditions of a boundary between an electrically positive plasma region and an electrically negative plasma region based on the acquired current-voltage curve group.

In accordance with another aspect of the present invention, there is provided a plasma measuring method for measuring electrical characteristics of a plasma in a vacuum chamber by using a Langmuir probe positioned in the plasma, the plasma being generated by supplying an energy to a plasma-generating gas containing an electrically negative gas and an electrically positive gas supplied into the vacuum chamber. The plasma measuring method includes: generating a reference plasma by supplying an electrically positive gas into the vacuum chamber while setting parameters of process conditions including a pressure in the vacuum chamber and a magnitude of the energy to reference levels; applying a voltage to the Langmuir probe positioned in the reference plasma and acquiring a reference current-voltage curve indicating a relationship between the applied voltage and a corresponding current to flow through the probe; generating a target plasma to be measured by supplying the plasma-generating gas into the vacuum chamber; applying a voltage to the Langmuir probe positioned in the target plasma and acquiring a current-voltage curve of the target plasma which indicates a relationship between the applied voltage and a corresponding current to flow through the probe; and determining whether the target plasma is an electrically positive plasma or an electrically negative plasma by comparing the reference current-voltage curve with the current-voltage curve of the target plasma.

In accordance with still another aspect of the present invention, there is provided a plasma measuring device for measuring electrical characteristics of a plasma generated in a vacuum chamber by supplying an energy to a plasma-generating gas containing an electrically negative gas and an electrically positive gas supplied into the vacuum chamber. The plasma measuring device includes: a Langmuir probe positioned in the plasma generated in the vacuum chamber; a power supply unit for applying a voltage to the Langmuir probe, an ampere meter for measuring a current to flow through the Langmuir probe; a control unit having a current-voltage curve creating unit for creating a current-voltage curve of the plasma based on the voltage and the current; and a display unit for displaying the current-voltage curve created by the current-voltage creating unit. The control unit stepwisely changes one of more parameters of process conditions to generate plasmas under at least three process conditions, the parameters including a flow rate ratio between the electrically positive gas and the electrically negative gas supplied into the vacuum chamber, a pressure in the vacuum chamber and a magnitude of the energy and displays a current-voltage curve for each of the plasmas on a screen of the display unit.

In accordance with still another aspect of the present invention, there is provided a plasma measuring device for measuring electrical characteristics of a plasma generated in a vacuum chamber by supplying an energy to a plasma generating gas containing an electrically negative gas and an electrically positive gas supplied into the vacuum chamber. The plasma measuring device includes: a Langmuir probe positioned in the plasma generated in the vacuum chamber; a power supply unit for applying a voltage to the Langmuir probe, an ampere meter for measuring a current to flow through the Langmuir probe; a control unit having a current-voltage curve creating unit for creating a current-voltage curve of the plasma based on the voltage and the current; and a display unit for displaying the current-voltage curve created by the current-voltage creating unit. The control unit displays on a screen of the display unit a current-voltage curve of a target plasma to be measured and a reference current-voltage curve of a plasma generated from an electrically positive gas by setting parameters of processing conditions including a pressure in the vacuum chamber and a magnitude of the energy to reference levels.

In the present invention, the current-voltage curve indicating the relation between the voltage and the current is acquired by using the Langmuir probe. Since the current-voltage curve of the electrically positive plasma is greatly different from that of the electrically negative plasma, the process conditions of the boundary between the electrically positive plasma region and the electrically negative plasma region can be obtained by stepwisely changing the process conditions. Moreover, whether the corresponding plasma is an electrically negative plasma or an electrically positive plasma can be determined by comparing the reference current-voltage curve of the plasma generated from an electrically positive gas and the current-voltage curve of the measuring target plasma which is generated from a gaseous mixture of an electrically positive gas and an electrically negative gas.

Herein, the electrically positive plasma and the electrically negative plasma have different etching rate distributions and electron density distributions. Therefore, in accordance with the present invention, the conditions in which the electron density distribution or the etching rate distribution changes greatly can be easily obtained. Hence, when an operator sets process conditions for obtaining desired etching rate distribution or electron density distribution, parameters of the process conditions can be easily optimized, which is highly effective in the process development.

### BRIEF DESCRIPTION OF THE DRAWINGS

FIG. 1 shows a cross sectional view of a plasma processing apparatus having a plasma measuring device in accordance with an embodiment of the present invention.

FIG. 2 is a top view illustrating a part of the plasma measuring device.

FIG. 3 provides a flowchart of a plasma measuring method.

FIG. 4 represents a characteristic diagram showing I-V curves used in the plasma measuring method.

FIG. 5 offers a flowchart of another plasma measuring method.

FIG. 6 presents a characteristic diagram depicting I-v curves used in the plasma measuring method.

FIG. 7 is a characteristic diagram of a test example performed to examine relationships between an electron density distribution and electrical characteristics of a plasma.

FIG. 8 is a characteristic diagram of a test example performed to examine relationships between an etching rate distribution and electrical characteristics of a plasma.

FIG. 9 provides a characteristic diagram of a reference example performed to examine changes in an etching rate distribution in the case where NF₃ gas is added to CF₄ gas.

FIG. 10 presents a characteristic diagram of another reference example performed to examine changes in the etching rate distribution in the case where NF₃ gas is added to CF₄ gas.

FIG. 11 represents a characteristic diagram of still another reference example performed to examine changes in the etching rate distribution in the case where NF₃ gas is added to CF₄ gas.

### DETAILED DESCRIPTION OF THE EMBODIMENT

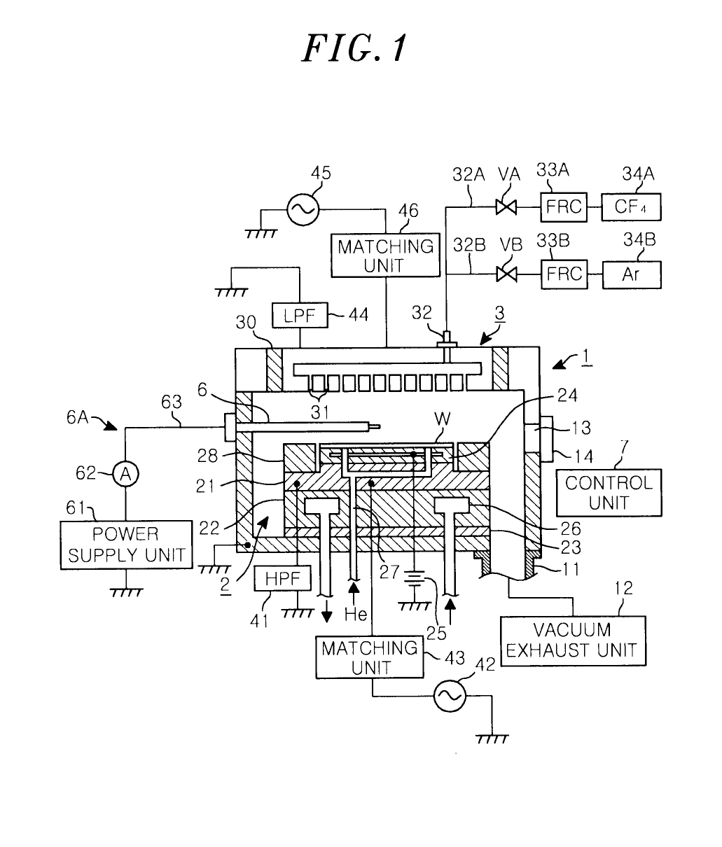

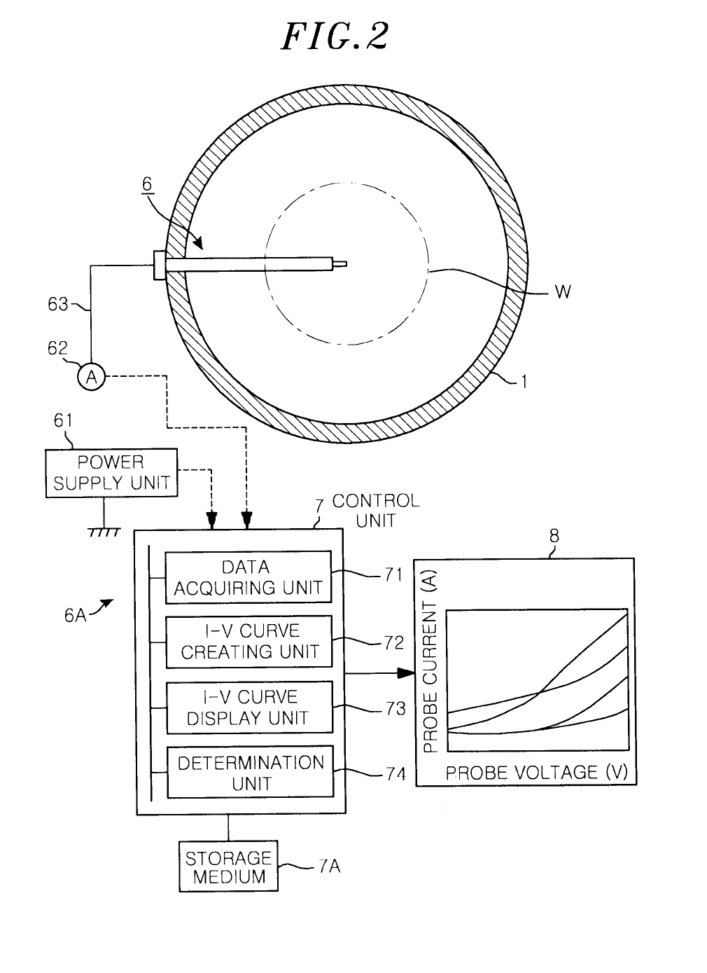

The embodiments of the present invention will be described by using an example in which the present invention is applied to a parallel plate type plasma processing apparatus. FIG. 1 shows a cross sectional view of a plasma processing apparatus having a plasma measuring device in accordance with an embodiment of the present invention. The plasma processing apparatus includes a processing chamber 1 serving as a vacuum vessel, a mounting table 2 installed at a center of a bottom surface of the processing chamber 1, and an upper electrode 3 provided above the mounting table 2 so as to face the mounting table 2.

The processing chamber 1 is grounded, and a vacuum exhaust unit 12 is connected to the bottom surface of the processing chamber 1 via a gas exhaust line 11. The vacuum exhaust unit 12 is connected to a pressure control unit (not shown), so that a pressure in the processing chamber 1 is maintained at a desired level. A transfer port 13 of the wafer W is provided on a wall surface of the processing chamber 1, and can be opened and closed by a gate valve 14.

The mounting table 2 includes a lower electrode 21 and a support 22 for supporting the lower electrode 21, and the mounting table 2 is disposed on the bottom surface of the processing chamber 1 with an insulation member 23 provided therebetween. An electrostatic chuck 24 is provided at an upper portion of the mounting table 2, and the wafer W is electrostatically attracted and held on the mounting table 2 by applying a voltage from a high voltage DC power supply 25. In addition, a temperature control path 26 through which a predetermined temperature control medium passes is formed in the mounting table 2, so that the temperature of the wafer W is maintained at a preset level. Furthermore, a gas channel 27 for supplying a heat transfer gas, e.g., He gas or the like, as a backside gas is formed in the mounting table 2. The gas channel 27 opens at a plurality of locations on a top surface of the mounting table 2.

The lower electrode 21 is grounded via a high pass filter (HPF) 41 and is connected to a high frequency power supply 42 for supplying a high frequency power of, e.g., 13.56 MHz. The high frequency power supplied from the high frequency power supply 42 is for attracting the ions in a plasma to the wafer W by applying a bias power to the wafer W. Further, a focus ring 28 is provided at an outer peripheral portion of the lower electrode 21 so as to surround the electrostatic chuck 24. The generated plasma is concentrated on the wafer W mounted on the mounting table 2 via the focus ring 28.

The upper electrode 3 is formed in a hollow shape and is attached to a ceiling portion of the processing chamber 1 via a shield ring 30 covering a peripheral portion of the upper electrode 3. Further, in a bottom surface of the upper electrode 3, a plurality of openings 31 through which the processing gas is injected into the processing chamber 1 is, e.g., uniformly arranged, serving as a gas shower head.

Moreover, a gas inlet line 32 serving as a gas supply line is formed on the top surface of the upper electrode 3. The gas inlet line 32 is branched at its upstream side into, e.g., two branch lines 32A and 32B, and the branch lines 32A and 32B are connected to gas supply sources 34A and 34B via valves VA and VB and flow rate controllers (FRC) 33A and 33B, respectively. The valves VA and VB and the flow rate controllers 33A and 33B constituting a gas supply system can control the supply of gases from the respective gas supply sources 34A and 34B and gas flow rates thereof in accordance with a control signal from a control unit to be described later.

In this embodiment, the plasma generating gas includes an electrically negative gas and an electrically positive gas. For example, the gas supply source 34A supplies an electrically negative gas, e.g., CF₄ gas, and the gas supply source 34B supplies an electrically positive gas, e.g., Ar gas. As for the electrically negative gas, it is possible to use CF₄ gas, SF₆ gas, Cl₂ gas, O₂ gas or the like. As for the electrically positive gas, it is possible to use Ar gas, N₂ gas, He gas or the like.

The upper electrode 3 is grounded via a low pass filter (LPF) 44 and is connected via a matching unit 46 to a high frequency power supply 45 for supplying a high frequency power of, e.g., 60 MHz, which is higher than the frequency of the power supplied from the high frequency power supply 42. The high frequency power supplied from the high frequency power supply 45 connected to the upper electrode 3 serves as a plasma generation medium for generating a plasma from an electrically negative gas and an electrically positive gas.

A plasma measuring device 6A of the present embodiment includes a Langmuir probe 6 for plasma measurement which is provided in the processing chamber 1. A leading end of the Langmuir probe 6 is positioned at a plasma generation region, e.g., a portion below the upper electrode 3 and above the center of the mounting table 2. Besides, a power supply unit 61 and an ampere meter 62 are connected through a line to a base end of the Langmuir probe 6, and the power supply unit 61 is grounded. As for the Langmuir probe 6, it is possible to use L2P (KOBELCO, Plasma Consult) (Trademark) or the like.

The power supply unit 61 can apply a voltage to the Langmuir probe 6while sweeping the voltage from a negative voltage to a positive voltage. When a voltage is applied to the Langmuir probe 6 positioned in the plasma, electrons or ions collide with the probe 6, so that a current (probe current) flows through the line 63 that connects the probe 6 and the power supply unit 61. Therefore, the ampere meter 62 can detect the current at that time.

In addition, the plasma measuring device 6A includes a control unit 7 and a display unit 8 to be described later. The control unit 7 includes, e.g., a computer having a CPU, a computer program and a memory. The computer program has instructions (steps) for performing predetermined measurement by sending control signals from the control unit 7 to each component of the plasma measuring device 6A. This computer program is stored in a computer storage medium 7A, e.g., a flexible disk, a compact disk, a hard disk, an MO (magneto-optical disk) or the like, and installed in the control unit.

Hereinafter, such components for performing the plasma measurement in accordance with the instructions of the computer program will be described. The control unit 7 has a data acquiring unit 71 for acquiring and storing as a table voltages (probe voltages) applied to the Langmuir probe 6 and corresponding probe currents detected by the ampere meter 62 in the case of applying the probe voltages; an I-V curve creating unit 72 for creating current-voltage curves (I-V curves) based on the probe voltages and the probe currents stored in the data acquiring unit 71; an I-V curve display unit 73 for displaying the created I-V curves of the process conditions on, e.g., a display screen (display unit) 8 of the computer; and a determination unit for determining a boundary between an I-V curve of a plasma in an electrically negative plasma region and an I-V curve of a plasma in an electrically positive plasma region in accordance with variation in the parameters and variation in the I-V curves, based on the displayed I-V curves.

Hereinafter, a plasma measuring method of the present embodiment will be described. First, process conditions are set. Herein, the process conditions include parameters such as a flow rate ratio between an electrically negative gas and an electrically positive gas, a pressure in the processing chamber 1 (vacuum chamber) and a magnitude of a high frequency power applied to the upper electrode 3. In this embodiment, at least three process conditions are set by stepwisely changing one or more of the above parameters (step S1).

To be specific, a case of changing a parameter, e.g., a flow rate ratio between an electrically positive plasma gas and an electrically negative plasma gas, will be described as an example. In this case, six process conditions are set, in which a flow rate ratio between CF₄ gas as an electrically negative gas and Ar gas as an electrically positive gas is changed while fixing the high frequency power applied to the upper electrode 3 to, e.g., about 500 W, the high frequency power applied to the lower electrode 21 to, e.g., about 100 W, and the pressure in the processing chamber 1 to, e.g., about 13.3 Pa (100 mTorr). At this time, the total flow rate of CF₄ gas and Ar gas is set to about 200 sccm, and the flow rate ratio therebetween is set as follows.

(Condition 1) CF₄ gas:Ar gas=200 sccm:0 sccm

(Condition 2) CF₄ gas:Ar gas=100 sccm:100 sccm

(Condition 3) CF₄ gas:Ar gas=50 sccm:150 sccm

(Condition 4) CF₄ gas:Ar gas=10 sccm:190 sccm

(Condition 5) CF₄ gas:Ar gas=5 sccm:195 sccm

(Condition 6) CF₄ gas:Ar gas=0 sccm:200 sccm

Moreover, a plasma is generated under each of the process conditions 1 to 6 (step S2). For example, in the case of the process condition 1, the processing chamber 1 is exhausted by the vacuum exhaust unit 12 via the gas exhaust line 11 so that the pressure in the processing chamber 1 is maintained at about 13.3 Pa (100 mTorr). Next, CF₄ gas and Ar gas as plasma-generating gases are supplied at flow rates of about 200 sccm and 0 sccm, respectively. A high frequency power of 60 MHz and 500 W is supplied to the upper electrode 3, and a high frequency power of 13.56 MHz and 100 W is supplied to the lower electrode 21. Accordingly, the plasma generating gas is turned into a plasma.

Thereafter, the Langmuir probe 6 is brought into contact with the generated plasma, and probe voltages are applied from the power supply unit 61 to the Langmuir probe 6 while sweeping the probe voltages. At this time, the probe currents flowing through the line 63 are detected by the ampere meter 62, and the probe voltage and the probe currents are correspondingly stored as a table in the data acquiring unit 71 (step S3). Next, I-V curves are created by the I-V curve creating unit 72 based on the probe voltages and the probe currents stored in the data acquiring unit 71 (step S4).

In this way, the I-V curves of the plasmas generated under the process conditions 1 to 6 are created, and the I-V curves are displayed on the same display screen of the computer by the I-V curve display unit 73 (step S5). Then, the boundary between the I-V curve in the electrically positive plasma region and the I-V curve in the electrically negative plasma region is determined by the determination unit 74 in accordance with the variation in the parameters and the variation in the I-V curves (step S6).

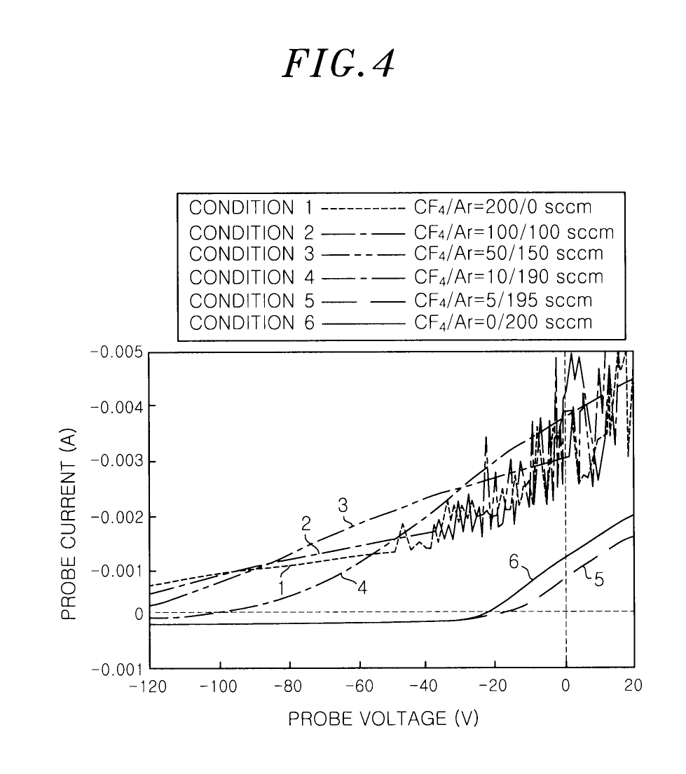

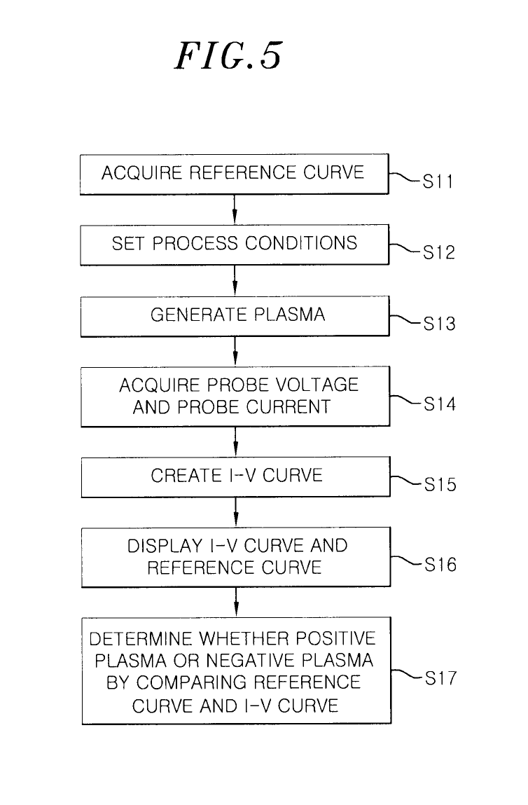

FIG. 4 shows the I-V curves of the plasmas generated under the process conditions 1 to 6, where the vertical axis indicates the probe voltage, and the horizontal axis represents the probe current. At this time, a current flowing from the power supply unit 61 to the Langmuir probe is referred to as a positive current, and a current flowing from the Langmuir probe 6 to the power supply unit 61 is referred to as a negative current.

From FIG. 4, it is seen that the I-V curves of the process conditions 1 to 4 have a substantially same behavior and the I-V curves of the process conditions 5 and 6 also have a substantially same behavior. When the flow rate of CF₄ gas serving as one of the parameters is changed by about 5 sccm between the process conditions 4 to 6, the I-V curves of the process conditions 5 and 6 are not greatly different whereas the I-V curves of the process conditions 4 and 5 are greatly different. Therefore, it is determined that, between the I-V curves of the process conditions 4 and 5, there exists the boundary between the I-V curves in the electrically positive plasma region the electrically negative plasma region since the variation in the current-voltage curves is great in comparison with the change of the parameter. For example, the determination result is displayed on the display screen 8.

Herein, the I-V curves of the process conditions 1 to 4 are determined to be within the electrically negative plasma region, and the I-V curves of the processing conditions 5 and 6 are determined to be within the electrically positive plasma region. Even though the plasma is electrically neutral, it is thought that the I-V curve becomes different depending on whether the plasma is in an electrically positive state or an electrically negative state as a voltage is applied to the Langmuir probe 6.

Specifically, the electrically negative plasma is a plasma having a larger amount of negative ions than that of electrons as described above and has a great electronegativity. Therefore, even if a probe voltage having a high negative potential, e.g., about −120 V, is applied from the power supply unit 61 to the Langmuir probe positioned in the plasma, the plasma has a negative potential greater than that of the power supply unit 61 and, thus, the electrons move from the plasma toward the Langmuir probe 6 (power supply unit 61) due to the potential difference between the plasma and the power supply unit 61. Accordingly, the current flows from the power supply unit 61 toward the Langmuir probe 6, and the probe current becomes the positive current. Further, as the negativeness of the probe voltage decreases gradually, the potential difference between the plasma and the power supply unit 61 increases and this further increases the probe current.

Meanwhile, the electrically positive plasma is a plasma having a larger amount of electrons than that of negative ions as described above and has a lower electronegativity than that of the electrically negative plasma. Therefore, when a probe voltage having a high negative potential, e.g., about −120 V, is applied from the power supply unit 61 to the Langmuir probe 6 positioned in the plasma, the plasma has a negative potential smaller than that of the power supply unit 61 and, thus, the electrons move from the Langmuir probe 6 (power supply unit 61) toward the plasma due to the potential difference between the plasma and the power supply unit 61. Accordingly, the current flows from the plasma toward the Langmuir probe 6, and the probe current becomes the negative current. However, the flowing direction of the probe current is reversed when the probe voltage has a certain potential as the negative potential applied from the power supply unit 61 toward the probe 6 decreases gradually (as the probe voltage increases).

In other words, in the case of the I-V curve of the process condition 6, when the probe voltage of about −20 V is applied, the plasma and the power supply unit 61 have substantially the same potential. Thus, the electrons do not move therebetween, and the probe current becomes zero. When the probe voltage greater than about −20 V is applied, the plasma has a negative potential greater than that of the power supply unit 61. Due to the potential difference between the plasma and the power supply unit 61, the electrons move from the plasma to the Langmuir probe 6. Accordingly, the current flows from the power supply unit 61 toward the plasma, and the probe current becomes the positive current.

As described above, it is possible to determine whether the generated plasma is the electrically negative or positive plasma based on the data obtained by acquiring the I-V curve of the corresponding plasma. Referring to FIG. 4, the plasmas generated under the process conditions 1 to 4 are determined as the electrically negative plasmas because the probe current is the positive current even when the probe voltage has a high negative potential of about −100 V. On the other hand, the plasmas generated under the process conditions 5 and 6 are determined as the electrically positive plasmas. This is because the probe current is the negative current when the negative potential of the probe voltage is lower than or equal to about −30 V, but reversely becomes the positive current when the negative potential of the probe voltage is decreased to about −20V to −10 V.

As such, although the plasma is electrically neutral (quasi-neutral), when a voltage is applied to the Langmuir probe 6 whose leading end is brought into contact with the plasma while sweeping the voltage from a negative potential to a positive potential, the probe current is detected as described above and the I-V curves shown in FIG. 4 can be obtained. Therefore, from the electrical point of view, it is understood that a positive current flows from the power supply unit 61 toward the plasma when a voltage is applied to the probe 6. Meanwhile, referring to the data of the process conditions 1 to 3, when the probe voltage is greater than or equal to about −50 V, the probe current fluctuates. This may be because the electrons in the plasma collide with the probe. Further, the negative ions may collide with the plasma.

The boundary between the I-V curve in the electrically positive plasma region and that in the electrically negative plasma region can be determined by an operator based on the I-V curves of the process conditions 1 to 6.

The present invention has been conceived by acquiring I-V curves for plasmas generated under at least three process conditions set by stepwisely changing, e.g., one selected from parameters of process conditions; and ascertaining the process condition(s) in which there exists a great variation in the I-V curves in accordance with the change of the parameter, based on the I-V curves displayed on the screen 8. Further, the process condition(s) in which there exists the great variation in the I-V curve in accordance with the change of the parameter is determined as the process condition(s) of the boundary between the electrically positive plasma region and the electrically negative plasma region.

As will be clearly seen from a test example to be described later, the electrically positive plasma and the electrically negative plasma have different properties, etching rate distributions and electron density distributions. Thus, if the process conditions of the boundary between the electrically positive plasma region and the electrically negative plasma region can be ascertained, it is possible to easily find the conditions in which the electron density distribution or the etching rate distribution changes greatly. Accordingly, when an operator sets process conditions for obtaining desired etching rate distribution or electron density distribution in a process development stage, it is possible to determine which one of an electrically positive plasma and an electrically negative plasma is needed. At this time, if the process conditions of the boundary between the electrically positive plasma region and the electrically negative plasma region can be obtained as in the above embodiment, the conditions of the parameters of the process conditions can be more finely set and, thus, the parameters can be easily optimized.

Even when the high frequency power supplied to the upper electrode 3 and/or the pressure in the processing chamber 1 are changed while fixing the flow rate ratio between the electrically negative gas and the electrically positive gas, the plasma state is changed although it is slight compared to the case of changing the flow rate ratio. Thus, even when the parameters (the high frequency power and/or the pressure in the processing chamber 1) are stepwisely changed, the I-V curve of the generated plasma becomes different as well. For that reason, the process conditions of the boundary between the electrically positive plasma region and the electrically negative plasma region can be obtained based on the variation in the parameters and the variation in the I-V curves.

Hereinafter, another embodiment will be explained. In this embodiment, whether a target plasma to be measured is an electrically positive plasma or an electrically negative plasma is determined by comparing a reference current-voltage curve (hereinafter, referred to as a “reference curve”) serving as an I-V curve of a reference plasma with an I-V curve of the target plasma which is generated under certain process conditions.

To be specific, the reference plasma is first generated, and the I-V curve of the reference plasma is acquired as a reference curve (step S11). Herein, the reference plasma is a plasma generated by using only an electrically positive gas, e.g., Ar gas, while setting parameters of the processing conditions such as a pressure in the processing chamber 1 and a high frequency power supplied to the upper electrode to reference levels. In that case, the reference curve that has been acquired in advance may be respectively used, or a new reference curve may be reacquired whenever the measurement is needed.

As for the process conditions of the reference plasma of this embodiment, a flow rate of Ar gas as an electrically positive gas is set to about 200 sccm; a high frequency power supplied to the upper electrode 3 is set to about 500 W; and a pressure in the processing chamber 1 is set to about 13.3 Pa (100 mTorr).

Further, process conditions for generating a target plasma to be measured are set (step S12). Specifically, parameters such as a flow rate ratio of an electrically negative gas and an electrically positive gas, a pressure in the processing chamber 1 and a high frequency power supplied to the upper electrode 3 are set. In this embodiment, the pressure in the processing chamber 1 and the high frequency power supplied to the upper electrode 3 are set to be identical to the parameters of the reference plasma. To be specific, the flow rate ratio of CF₄ gas as the electrically negative gas and Ar gas as the electrically positive gas(CF₄ gas:Ar gas), is set to be 10 sccm:190 sccm; the high frequency power supplied to the upper electrode 3 is set to about 500 W; the high frequency power supplied to the lower electrode 21 is set to about 100 W; and the pressure in the processing chamber 1 is set to about 13.3 Pa (100 mTorr).

Then, the plasma-generating gas is turned into a plasma under the process conditions (step S13). Next, the Langmuir probe 6 is brought into contact with the plasma, and a probe voltage applied to the probe 6 and a probe current flowing through the line 63 are correspondingly acquired by the data acquiring unit 71 (step S14). Thereafter, an I-V curve is created by the I-V curve creating unit 72 (step S15).

Next, the reference curve and the I-V curve of the target plasma are displayed on the same display screen 8 of the computer by the I-V curve display unit 73 (step S16). Then, whether the target plasma is an electrically positive plasma or an electrically negative plasma is determined by the determination unit 74 by comparing the reference curve and the I-V curve of the target plasma, and the result is displayed (step S17). At this time, an operator may determine whether the target plasma is an electrically positive plasma or an electrically negative plasma.

Moreover, in this embodiment, the display unit 73 corresponds to a unit for displaying on the same screen of display unit the reference curve and the current-voltage curve of the target plasma. The determination unit 74 corresponds to a unit for determining whether the target plasma is an electrically positive plasma or an electrically negative plasma by comparing the reference curve and the I-V curve of the target plasma.

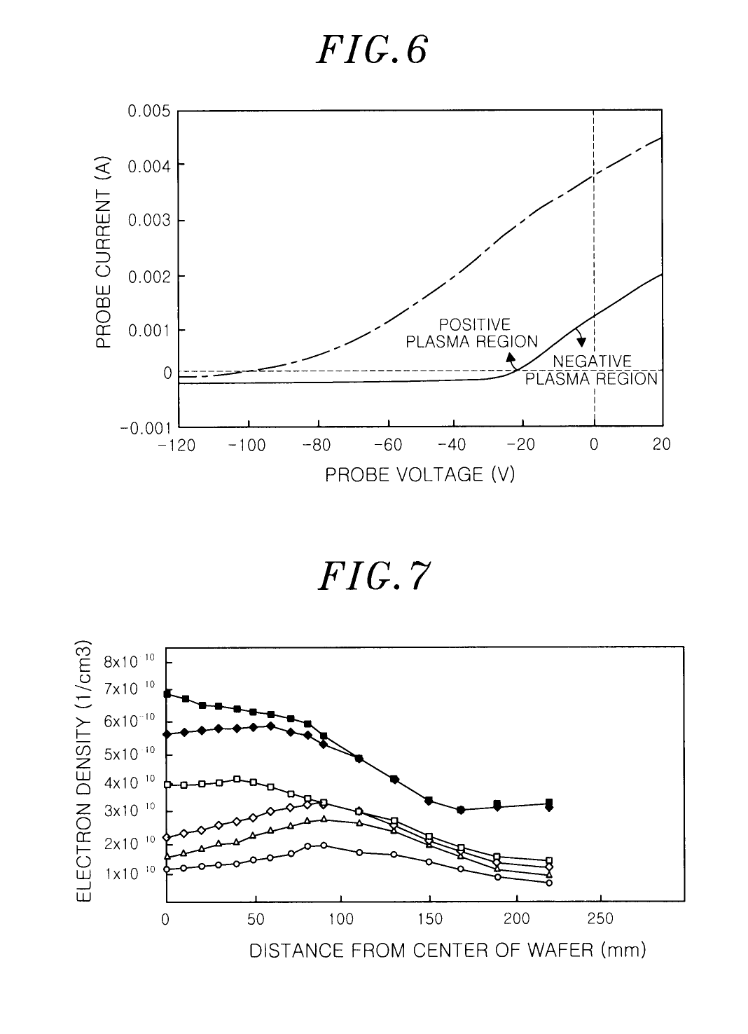

FIG. 6 is a characteristic diagram showing the reference curve and the I-V curve of the target plasma, where the solid line indicates the reference curve, and the single dotted line represents the I-V curve of the target plasma. Further, in FIG. 6, the vertical axis indicates the probe voltage, and the horizontal axis represents the probe current. At this time, the current flowing from the power supply unit 61 toward the Langmuir probe 6 is referred to as a positive current, and the current flowing from the Langmuir probe 6 toward the power supply unit 61 is referred to as a negative current.

In this embodiment, the process conditions of the boundary between the electrically positive plasma region and the electrically negative plasma region are ascertained from the data obtained in the above-described embodiment. As set forth above, when Ar gas as an electrically positive gas is turned into a plasma, an electrically positive plasma is generated. Further, when the flowing direction of a probe current is reversed, a corresponding prove voltage is shifted to a positive side in the I-V curve of the plasma generated under the process condition 5 (CF₄ gas:Ar gas=5 sccm:195 sccm) compared to that in the I-V curve of the plasma generated under the process conditions 6 using only Ar gas (CF₄ gas:Ar gas=0 sccm:200 sccm) in the above-described embodiment. Therefore, the I-V curve of the plasma generated by using only Ar gas is regarded as an I-V curve of the boundary of the electrically positive plasma region. Based on the above, it is possible to determine whether the plasma is an electrically positive plasma or an electrically negative plasma.

The shift between the electrically positive plasma and the electrically negative plasma occurs sharply in accordance with changes in the flow rate of the electrically negative gas. The gas flow rate has a threshold value, and an I-V curve changes greatly around the threshold value (boundary between the electrically positive plasma region and the electrically negative plasma region). Thus, whether the target plasma to be measured is an electrically positive plasma or an electrically negative plasma is determined by whether the I-V curve is shifted to an electrically positive or negative side of the threshold value. In this embodiment, the I-V curve of the target plasma is shifted to the negative side compared to the I-V curve of the plasma generated by using only Ar gas which is considered as the threshold. As a result, the target plasma is determined as an electrically negative plasma.

In this embodiment, whether the plasma generated under specific process conditions is an electrically positive plasma or an electrically negative plasma is determined by comparing a reference curve, i.e., an I-V curve of a reference plasma, with an I-V curve of the specific process conditions. Therefore, it is possible to easily determine whether the plasma generated under preset process conditions is an electrically positive plasma or an electrically negative plasma. Accordingly, when an operator sets process conditions for obtaining desired etching rate distribution or electron density distribution, the parameters of the process conditions can be easily optimized.

For example, in order to improve in-plane uniformity of the etching rate distribution, after an electrically negative plasma is generated by using CF₄ gas as the electrically negative gas and Ar gas as the electrically positive gas it may be employed to add thereto SF₆ gas having a greater electronegativity, for example. Accordingly, it is possible to easily decide a next operation required to ensure desired etching rate distribution or electron density distribution by ascertaining the electrical characteristics of the plasma. As a result, the parameters of the process conditions can be easily optimized.

In this embodiment, a reference plasma is generated by using only an electrically positive gas. However, an electrically negative gas of a few percentage points, e.g., about 2 to 3%, may be added to the electrically positive gas. This is because an electrically positive plasma can be generated even when an electrically negative gas of about 2.5% is added to an electrically positive gas as in the process condition 5.

### Test Examples

Hereinafter, test examples performed to examine effects of the present embodiment will be described.

(Measurement of Electron Density Distribution)

Plasmas were generated under the process conditions 1 to 6 of the aforementioned embodiment by using the plasma measuring device shown in FIG. 1, and electron density distributions of the plasmas were measured. As for the process conditions 1 to 6, a high frequency power supplied to the upper electrode 3 was set to 500 W; a high frequency power supplied to the lower electrode 21 was set to 100 W; and a pressure in the processing chamber 1 was set to 13.3 Pa (100 mTorr). The flow rate ratio of the plasma generating gas was set as follows.

(Condition 1) CF₄ gas:Ar gas=200 sccm:0 sccm

(Condition 2) CF₄ gas:Ar gas=100 sccm:100 sccm

(Condition 3) CF₄ gas:Ar gas=50 sccm:150 sccm

(Condition 4) CF₄ gas:Ar gas=10 sccm:190 sccm

(Condition 5) CF₄ gas:Ar gas=5 sccm:195 sccm

(Condition 6) CF₄ gas:Ar gas=0 sccm:200 sccm

FIG. 7 illustrates the measured electron density distribution, where the horizontal axis indicates a distance from the center of the wafer, and the vertical axis represents an electron density. Data of the process conditions 1 to 6 are indicated by notations of ◯, Δ, ⋄, □, ♦ and ▪, respectively.

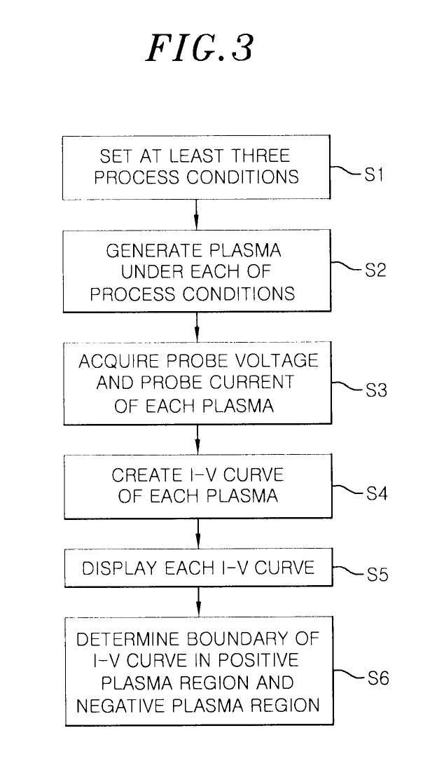

From the result, it was seen that the electron density was higher under the process conditions 5 and 6 than under the process conditions 1 to 4, and that the behaviors of the data of the process conditions 1 to 4 were similar and the behaviors of the data of the process conditions 5 and 6 were also similar. Herein, it was found from the results of FIG. 3 that an electrically negative plasma was generated under the process conditions 1 to 4 and an electrically positive plasma was generated under the process conditions 5 and 6. Accordingly, it has been found that the electron density distribution of the plasma was changed greatly between the electrically positive plasma and the electrically negative plasma.

(Measurement of Etching Rate Distribution of Si)

Plasmas were generated under the process conditions 1 to 6 of the aforementioned embodiment by using the plasma measuring device shown in FIG. 1, and etching rate distributions of the plasmas were measured. The process conditions 1 to 6 were set as described above.

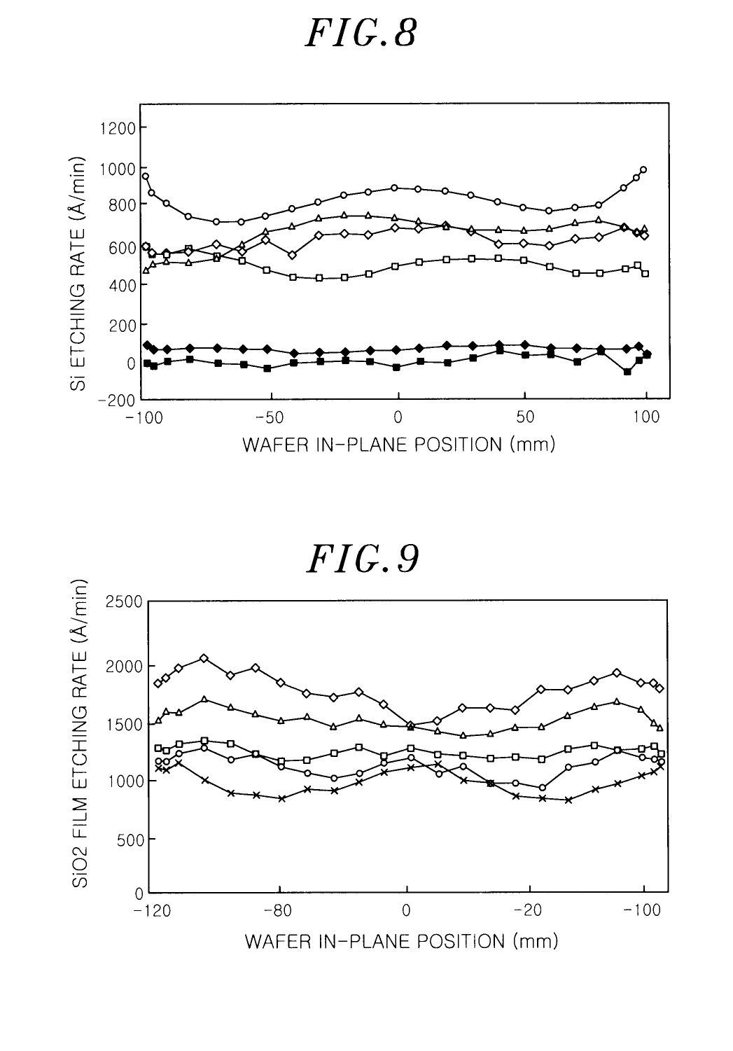

FIG. 8 shows the measured etching rate distribution, where the horizontal axis indicates in-plane position of wafer, and the vertical axis represents an etching rate. Data of the process conditions 1 to 6 are indicated by notations of ◯, Δ, ⋄, □, ♦ and ▪ respectively.

From the results, it was seen that the etching rate was lower in the process conditions 5 and 6 compared to that in the process conditions 1 to 4, and that the behaviors of the data of the process conditions 1 to 4 were similar and the behaviors of the data of the process conditions 5 and 6 were also similar. Herein, as described above, an electrically negative plasma was generated under the process conditions 1 to 4 and an electrically positive plasma was generated under the process conditions 5 and 6. Therefore, it has been found that the etching rate distribution was changed greatly between the electrically positive plasma and the electrically negative plasma.

(Reference Test: Measurement of Etching Rate Distribution of SiO₂)

Plasmas were generated under process conditions of 11 to 15 by using the plasma measuring device shown in FIG. 1, and etching rate distributions of the plasmas were measured. As for the process conditions 11 to 15, a high frequency power applied to the upper electrode 3 was set to 1500 W; a high frequency power applied to the lower electrode 21 was set to 100 W; and a pressure in the processing chamber 1 was set to 13.3 Pa (100 mTorr). Further, CF₄ gas and NF₃ gas as plasma-generating gases were used, and a flow rate ratio therebetween in each of the process conditions 11 to 15 was set as follows.

(Condition 11) CF₄ gas:NF₃ gas=100 sccm:0 sccm

(Condition 12) CF₄ gas:NF₃ gas=100 sccm:5 sccm

(Condition 13) CF₄ gas:NF₃ gas=100 sccm:10 sccm

(Condition 14) CF₄ gas:NF₃ gas=100 sccm:25 sccm

(Condition 15) CF₄ gas:NF₃ gas=100 sccm:50 sccm

FIG. 9 shows the measured etching rate distribution, where the horizontal axis indicates in-plane position of wafer, and the vertical axis represents an etching rate. Data of the process conditions 11 to 15 are indicated by notations of ×, ◯, □, Δ and ⋄, respectively.

(Reference Test: Measurement of Etching Rate Distribution of SiN)

Plasmas were generated under the process conditions 11 to 15 by using the plasma measuring device shown in FIG. 1, and etching rate distributions of the plasmas were measured. The process conditions 11 to 15 were set as described above.

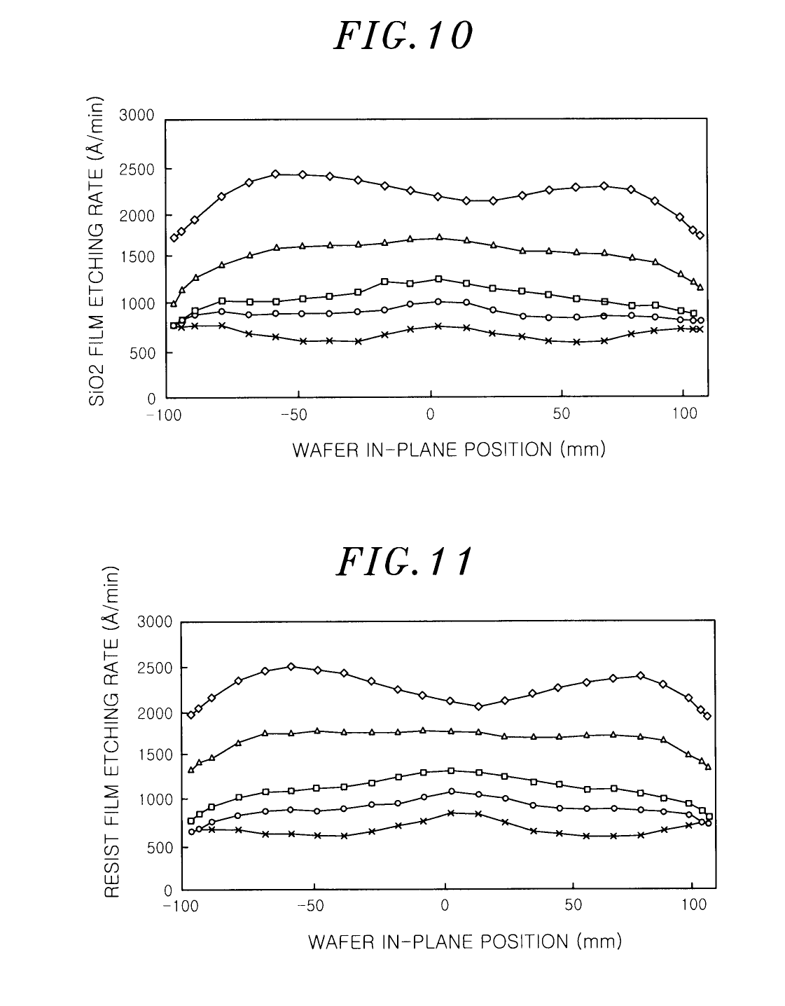

FIG. 10 shows the measured etching rate distribution, where the horizontal axis indicates in-plane position of wafer, and the vertical axis represents an etching rate. Data of the process conditions 11 to 15 are indicated by notations of ×, ◯, □, Δ and ⋄, respectively.

(Reference Test: Measurement of Etching Rate Distribution of Photoresist)

Plasmas were generated under the process conditions 11 to 15 by using the plasma measuring device shown FIG. 1, and etching rate distributions of the plasmas were measured. The process conditions 11 to 15 were set as described above.

FIG. 1 shows the measured etching rates, where the horizontal axis indicates in-plane position, and the vertical axis represents an etching rate. Data of the process conditions 11 to 15 are indicated by notations of ×, ◯, □, Δ and ⋄, respectively.

The reference tests (FIGS. 9 to 11) were performed to examine variation in the etching rate distribution measured in the case of adding to CF₄ gas NF₃ gas having a greater electron affinity than CF₄ gas. Herein, a gas having a greater electron affinity than CF₄ gas indicates a gas that easily generates negative ions compared to CF₄ gas.

From the results, it has been seen that the in-plane uniformity of the etching rate was improved in the process conditions 12 and 13 in which NF₃ gas is added compared to that in the processing gas 11 in which NF₃ gas is not added. However, it has been found that the in-plane uniformity of the etching rate was deteriorated in the process conditions 14 and 15 in which a large amount of NF₃ gas is added. This shows that although the in-plane uniformity of the etching rate is improved by generating an electrically negative plasma and adding an electrically negative gas having a great electron affinity, such a gas is required to be added in an adequate level.

As described above, the target plasma of the present embodiment is generated in a vacuum chamber by supplying an energy to a plasma-generating gas. The energy may be a high frequency power as described above, or may also be an energy using microwaves or various types of energies that generates a plasma. Moreover, the Langmuir probe may be provided in the vacuum chamber in advance, or may be provided in the vacuum chamber after the plasma is generated.

While the invention has been shown and described with respect to the embodiments, it will be understood by those skilled in the art that various changes and modification may be made without departing from the scope of the invention as defined in the following claims.

1-6. (canceled)

7. A plasma measuring device for measuring electrical characteristics of a plasma generated in a vacuum chamber by supplying an energy to a plasma-generating gas containing an electrically negative gas and an electrically positive gas supplied into the vacuum chamber, the plasma measuring device comprising:
a Langmuir probe positioned in the plasma generated in the vacuum chamber;
a power supply unit for applying a voltage to the Langmuir probe,
an ampere meter for measuring a current to flow through the Langmuir probe;
a control unit having a current-voltage curve creating unit for creating a current-voltage curve of the plasma based on the voltage and the current; and
a display unit for displaying the current-voltage curve created by the current-voltage creating unit,
wherein the control unit stepwisely changes one of more parameters of process conditions to generate plasmas under at least three process conditions, the parameters including a flow rate ratio between the electrically positive gas and the electrically negative gas supplied into the vacuum chamber, a pressure in the vacuum chamber and a magnitude of the energy and displays a current-voltage curve for each of the plasmas on a screen of the display unit.

8. The plasma measuring device of claim 7, further comprising a unit for obtaining process conditions of a boundary between an electrically positive plasma region and an electrically negative plasma region based on variation in the parameters and variation in the current-voltage curves.

9. A plasma measuring device for measuring electrical characteristics of a plasma generated in a vacuum chamber by supplying an energy to a plasma generating gas containing an electrically negative gas and an electrically positive gas supplied into the vacuum chamber, the plasma measuring device comprising:
a Langmuir probe positioned in the plasma generated in the vacuum chamber;
a power supply unit for applying a voltage to the Langmuir probe,
an ampere meter for measuring a current to flow through the Langmuir probe;
a control unit having a current-voltage curve creating unit for creating a current-voltage curve of the plasma based on the voltage and the current; and
a display unit for displaying the current-voltage curve created by the current-voltage creating unit,
wherein the control unit displays on a screen of the display unit a current-voltage curve of a target plasma to be measured and a reference current-voltage curve of a plasma generated from an electrically positive gas by setting parameters of processing conditions including a pressure in the vacuum chamber and a magnitude of the energy to reference levels.

10. The plasma measuring device of claim 9, wherein the control unit further has a unit for determining whether the target plasma is an electrically positive plasma or an electrically negative plasma by comparing the reference current-voltage curve with the current-voltage curve of the target plasma to be measured.
